(19) United States
(12) Patent Application Publication
(10) Pub. No.: US 2012/0140945 A1
(43) Pub. Date: Jun. 7, 2012

(54) Audio Apparatus

(75) Inventor: Neil John Harris, Cambourne (GB)

(73) Assignee: NEW TRANSDUCERS LIMITED, Cambourne, Cambridgeshire (GB)

(21) Appl. No.: 13/386,586

(22) PCT Filed: Jul. 21, 2010
(86) PCT No.: PCT/GB2010/051195

§ 371 Date: Feb. 24, 2012

(30) Foreign Application Priority Data
Jul. 24, 2009 (GB) 0912919.8

(51) Int. Cl. H04B 1/00; H04R 1/40

(52) U.S. Cl. 381/86; 381/97

(57) ABSTRACT

Apparatus for providing different audio signals in a plurality of zones of a single enclosed space, comprising loudspeakers associated with, and positioned in, each zone to radiate an audio output, means capable of supplying a different audio signal to the loudspeakers in each zone, signal processing means comprising means for dividing the audio frequency spectrum of each audio signal into higher and lower parts, means for directing the higher frequencies radiated in their respective zones, and means for varying the phase, and delay of the lower frequencies to tend to cancel sound radiation outside their respective zones.

### TECHNICAL FIELD

The invention relates to audio apparatus for providing different audio outputs in a plurality of zones of a single enclosed space, for example, within a vehicle.

### DISCLOSURE OF INVENTION

According to one aspect of the invention there is provided apparatus for providing different audio outputs in a plurality of zones of a single enclosed space, comprising loudspeakers associated with, and positioned in, each zone to radiate an audio output, means capable of supplying a different audio signal to the loudspeakers in each zone, signal processing means comprising means for dividing the audio frequency spectrum of each audio signal into higher and lower parts, means for directing the higher frequencies radiated in their respective zones, and means for varying any of the amplitude, phase and delay of the lower frequencies to tend to cancel radiation outside their respective zones.

According to another aspect of the invention, there is provided a method of providing different audio signals in a plurality of zones of a single enclosed space, comprising arranging loudspeakers in or adjacent to each zone to radiate an audio output in the associated zone, supplying a different audio signal to the loudspeakers in each zone, processing the audio signals including dividing the audio frequency spectrum of each audio signal into higher and lower parts, directing the higher frequencies radiated in their respective zones, and varying the phase and delay of the lower frequencies to tend to cancel sound radiation outside their respective zones.

In both complementary aspects, different listeners in the single enclosed space may be simultaneously presented with different desired listening sensations. The different sensations include different audio channels and the possibility of one of the listeners choosing an audio-free experience (i.e. quiet relative to fellow passengers). In other words, tending to cancel sound radiation outside their respective zones means that sound radiation from said loudspeaker is reduced (or preferably minimised) in at least one other zone compared to its sound radiation in its associated zone. Anywhere else in the cabin may experience a combination of the audio signals, but this is unimportant. The following features apply to both aspects.

The enclosed space may be the cabin of a vehicle, e.g. an automobile or aeroplane. The cabin may be trimmed internally with at least one resilient panel, and at least one of the loudspeakers in each zone may be coupled to drive a portion of the at least one trim panel as an acoustic diaphragm. The cabin may be trimmed internally with a headlining, e.g. the resilient panel may form part or all of the headlining. At least one of the loudspeakers in each zone may be coupled to drive a portion of the headlining as an acoustic diaphragm. In this way, the loudspeaker apparatus would not present any visual disturbance to the interior décor.

The loudspeakers in each zone may comprise a cluster having at least one lower frequency driver and an array of higher frequency drivers. The audio frequency dividing means may be arranged so that the division occurs around 1500 Hz, i.e. higher frequencies are above 1500 Hz and lower frequencies below 1500 Hz.

The signal processing means may comprise means for processing the higher frequency signal to the array of higher frequency drivers to control the directivity of the radiation from the array. The signal processing means may employ linear superposition for the lower frequencies to tend to cancel radiation outside their respective zones. The at least one lower frequency driver in or associated with each zone may be a bending wave diaphragm positioned in the near field with respect to a listener in the same zone.

Sound pressure levels at the respective zones may be detected at one or more test positions by measurement and/or modelling. The detected sound pressure levels may be processed to determine (i.e. by measurement) a transfer function of the input signal, i.e. a function which measures the transfer of force applied at the test position to each loudspeaker. The processing may further comprise inferring the inverse of this transfer function, i.e. the transfer function necessary to produce a pure impulse at the test position from each loudspeaker.

The inferring step may be by direct calculation so that measurement of the transfer function iₚ^{T} is followed by inversion to obtain (iₚ^{T})⁻¹. Alternatively, the inferring step may be indirect, e.g. using feedback adaptive filter techniques to implicitly invert iₚ^{T}. Alternatively, the inferring step may be heuristic, e.g. using parametric equalisation processing, and adjusting the parameters to estimate the inverse transfer function.

Alternatively, the inferring step may be approximated by reversing the measured time responses, which in the frequency domain is equivalent to complex conjugation, thus generating the matched filter response. In this case, the result of applying the filter is not a pure impulse, but the autocorrelation function.

The resulting inverse transfer functions may be stored for later use by the apparatus, for example in a transfer function matrix with the inverse transfer function for each of the plurality of loudspeakers stored at an associated coordinate in the matrix. The spatial resolution of the transfer function matrix may be increased by interpolating between the calibration test points.

The time-reversed responses may be generated by adding a fixed delay which is at least as long as the duration of the detected signal. The fixed delay may be at least 5 ms, at least 7.5 ms or at least 10 ms. The measured time response may be normalised before filtering, e.g. by dividing by the sum of all measured time responses, to render the response more spectrally white.

The audio signal for a particular zone (i.e. desired listening sensation) may be a maximum response at a given test point. Thus, the output signals for each loudspeaker may be in-phase with each other, whereby all the displacements generated by the loudspeakers add up to the maximum displacement at the given test point. It is noted, that at other test points, there may be phase cancellation.

Alternatively, the audio signal for a particular zone (i.e. desired listening sensation) may be a minimum response at a given test point. Thus, the output signals for each loudspeaker may be selected so that the displacements provided at the test position (i.e. so that the appropriate transfer functions) sum to zero. With two loudspeakers, this may be achieved by inverting one output signal relative to the other.

The desired listening sensation may be a maximum at a first test point and a minimum at a second test point (e.g. a maximum for the driver location and a minimum for the passenger location or vice versa). Alternatively, the desired listening sensation may be a response which is between the minimum or maximum at a given test position, for example, where the responses at multiple test positions are to be taken into account.

One or more of the loudspeakers may comprise a vibration exciter for applying a bending wave vibration to a diaphragm, e.g. the resilient panel. The vibration exciter may be electro-mechanical. The exciter may be an electromagnetic exciter. Such exciters are well known in the art e.g. from WO97/09859, WO98/34320 and WO99/13684, belonging to the applicant and incorporated herein by reference. Alternatively, the exciter may be a piezoelectric transducer, a magneto-strictive exciter or a bender or torsional transducer (e.g. of the type taught in WO 00/13464). The exciter may be a distributed mode actuator, as described in WO01/54450, incorporated herein by reference. A plurality of exciters (perhaps of different types) may be selected to operate in a co-ordinated fashion. The or each exciter may be inertial.

One or more of the loudspeakers may be a panel-form member which is a bending wave device, for example, a resonant bending wave device. For example, one or more of the loudspeakers may be a resonant bending wave mode loudspeaker as described in International Patent Application WO97/09842 which is incorporated by reference. Thus, as explained in more detail below, the exciters in each source driving the bending wave devices, particularly the low frequency devices, may be driven by signals which are processed in phase and amplitude using the theory of linear superposition to provide directional and localised different audio signals to listeners in the relative near field.

The invention further provides processor control code to implement the above-described methods, in particular on a data carrier such as a disk, CD- or DVD-ROM, programmed memory such as read-only memory (firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very High speed integrated circuit Hardware Description Language). As the skilled person will appreciate such code and/or data may be distributed between a plurality of coupled components in communication with one another.

### BRIEF DESCRIPTION OF DRAWINGS

The invention is diagrammatically illustrated, by way of example, in the accompanying drawings in which:

FIGS. 1a and 1 b are schematic illustrations of two variations of audio apparatus;

FIG. 1c is a schematic illustration of a detail of FIG. 1a or 1b;

FIG. 1d is a block diagram of the components of the audio apparatus of FIG. 1a or FIG. 1b;

FIG. 1e is a schematic illustration of the principle of linear superposition;

FIG. 2 is a schematic model of an enclosed space in which the audio apparatus of FIGS. 1a to 1c may be located;

FIGS. 3a to 3c show the pressure response against frequency for the driver source, the passenger source and the rear source, respectively;

FIGS. 4a and 4b show the sound pressure level at 800 Hz on the listening plane of FIG. 2 for the driver source of FIG. 3a and rear source of FIG. 3c, respectively;

FIG. 5a shows the transfer functions for each of the sources of FIG. 1a;

FIG. 5b shows the mean response for each of the filtered sources of FIG. 5a;

FIG. 5c shows the pressure response against frequency at each of the three locations of FIG. 1a;

FIGS. 6a to 6d show the sound pressure level at 283 Hz, 400 Hz, 576 Hz and 800Hz on the listening plane of FIG. 2;

FIG. 7a is a block diagram of a parallel solver;

FIG. 7b is a block diagram of a recursive solver;

FIG. 8a is a block diagram of a variation of FIG. 1d, and

FIG. 8b is a flow chart showing the training mode of the system of FIG. 8a.

### DETAILED DESCRIPTION OF DRAWINGS

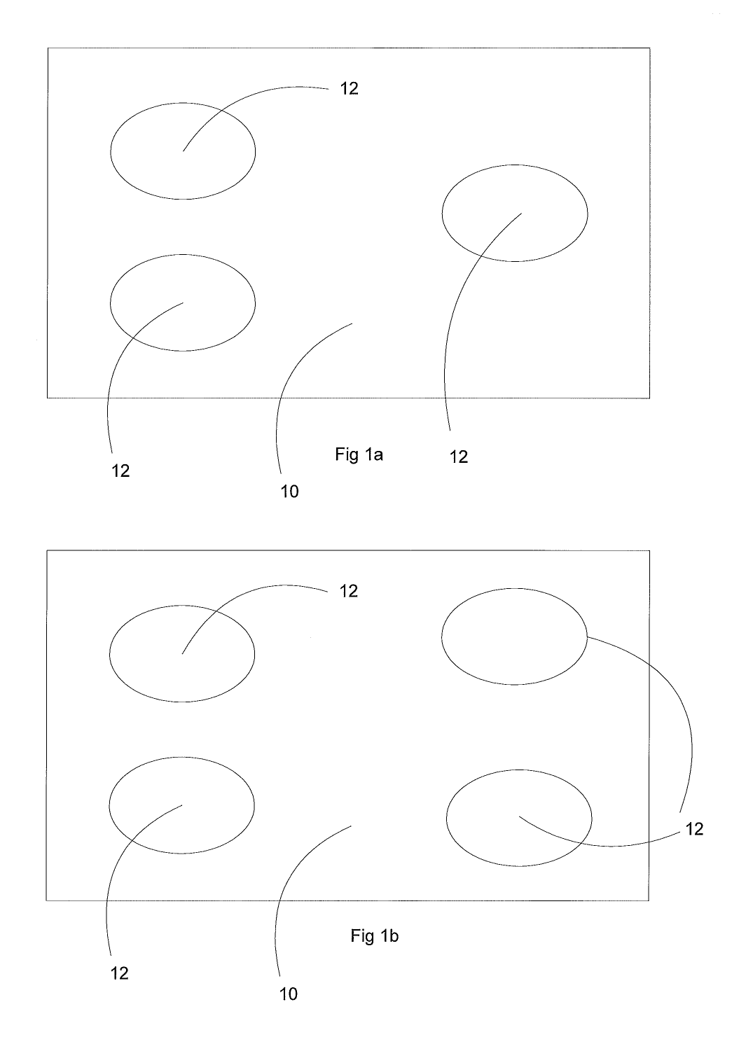

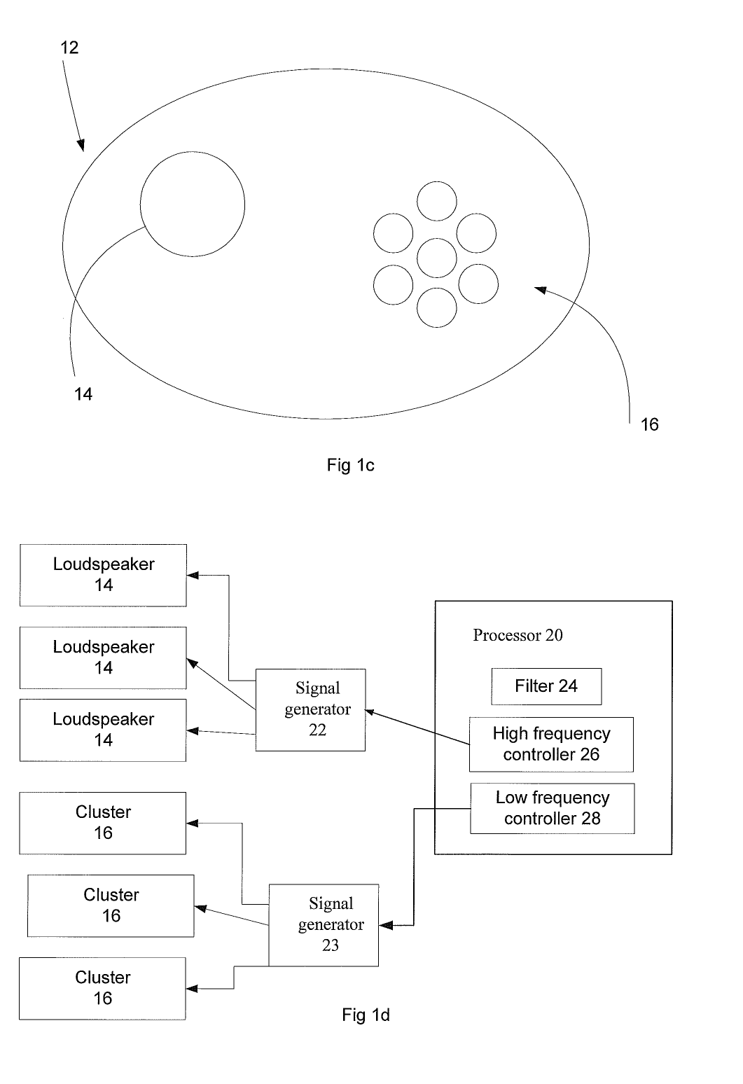

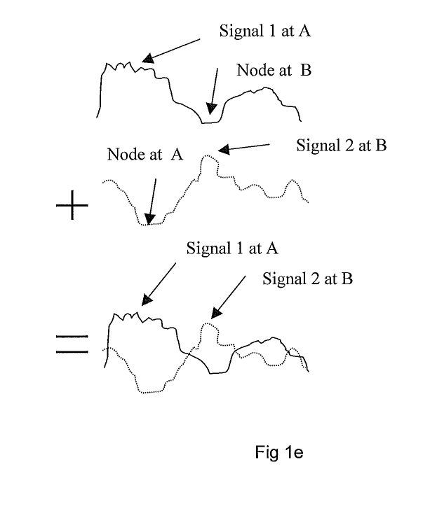

FIGS. 1a and 1b show two embodiments of audio apparatus which generate separate listening experiences in an enclosed space (namely a vehicle cabin) whereby different listeners are simultaneously presented with different audio channels. In FIG. 1a, there are three sources 12 mounted to a panel 10 which forms the headlining of a vehicle cabin. There are two sources 12 at the front of the vehicle and towards the sides of the vehicle cabin. One is positioned generally above a driver and a second positioned generally above a passenger. These two sources 12 thus form a symmetrically arranged pair. The third source 12 is centrally mounted towards the rear of the cabin to provide sound to passengers in the rear seats. FIG. 1b is generally similar to that of FIG. 1a except that the central rear source 12 is replaced with two symmetrically arranged sources 12 to form a total of four sources. The spacing and type of loudspeaker are parameters for determining the desired listening experiences.

FIG. 1c shows one arrangement for each of the sources of FIGS. 1a and 1b. There may be a single low frequency driver 14. This may be an exciter mounted to the headlining or other resilient panel within the enclosed space to excite bending wave vibration to provide low frequency sound radiation. As explained in more detail below, the exciters in each source are driven by signals which are processed in phase and amplitude using the theory of linear superposition to provide directional and localised different audio signals to listeners in the relative near field. There is also a cluster 16 of seven high frequency drivers. These may also be direct drive of the vehicle headliners. The exciters may be the same or different kinds of exciters. The division between high and low frequencies is approximately 1500 Hz.

FIG. 1d shows the system components. A processor 20 provides signals to two signal generators 22,23 which provide the independent audio signals for each loudspeaker. A first signal generator 22 provides independent audio signals to each low frequency loudspeaker 14. A second signal generator 23 provides independent audio signals to each cluster 16 of high frequency loudspeakers. Three loudspeakers are shown but there could be any number of loudspeakers.

Due to the wide range of acoustic wavelengths present in the audible spectrum, it is envisaged that more than one approach will be required to generate the desired listening experience. Accordingly, the processor 20 comprises a filter 24 for dividing the audio frequency spectrum of each audio signal into higher and lower parts. At high frequencies, a combination of directivity control and array processing techniques is employed to direct beams of sound to each listener. Control of side-lobes means that other listeners would receive much less sound. This functionality is provided by the high frequency controller 26.

Control of high frequency arrays is well known. The main limitation is that the array should be large enough compared with the wavelength of sound that it is attempting to steer. Example arrays are taught in:

http://gow.epsrc.ac.uk/ViewGrantaspx?GrantRef=GR/S63915/01
http://en.wikipedia.org/wiki/Directional Sound#Speaker arrays

As explained in more detail below, at low frequencies, all sources would be energised with appropriate amplitude, phase and delay variation to result in the desired listening experiences, including cancellation at designated quiet zones. This functionality is provided by the low frequency controller 28, e.g. using linear superposition which allows the generation of multiple audio zones. For example, as shown in FIG. 1e, a first signal 1 from a first source generates a maximum at a listening zone A and a minimum at listening zone B. A second signal 2 from a second source generates a maximum at a listening zone B and a minimum at listening zone A. By linear superposition, each listening point receives only its intended signal. Anywhere else in the enclosed space will experience a combination of the signals, but this is unimportant. This feature may be termed simultaneous dual region acoustics since two simultaneous audio experiences are provided at spatially separate locations. This may be extended to multiple signals and multiple regions to provide simultaneous multi-region acoustics.

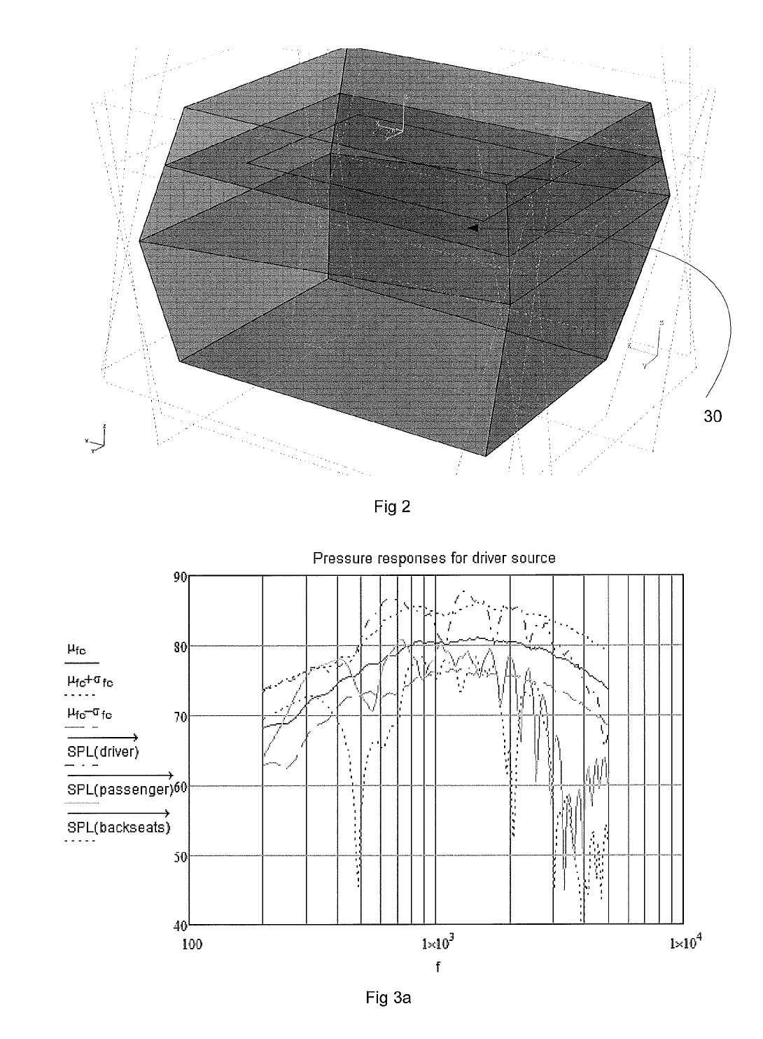

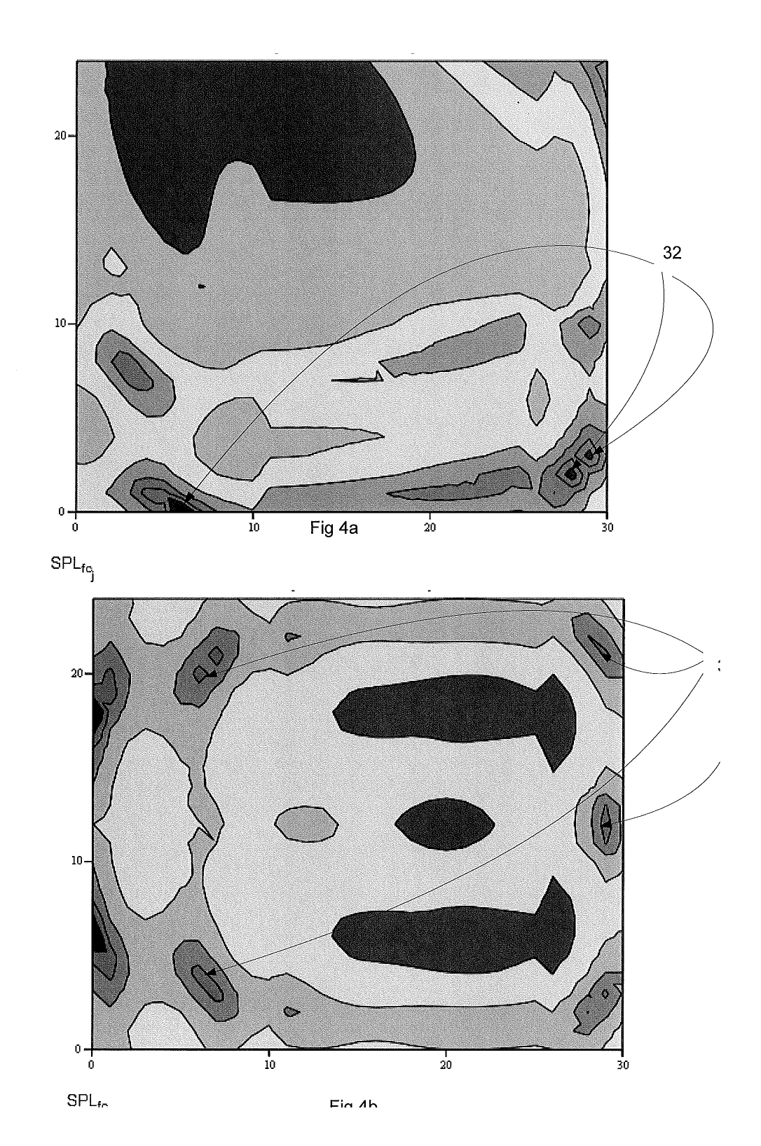

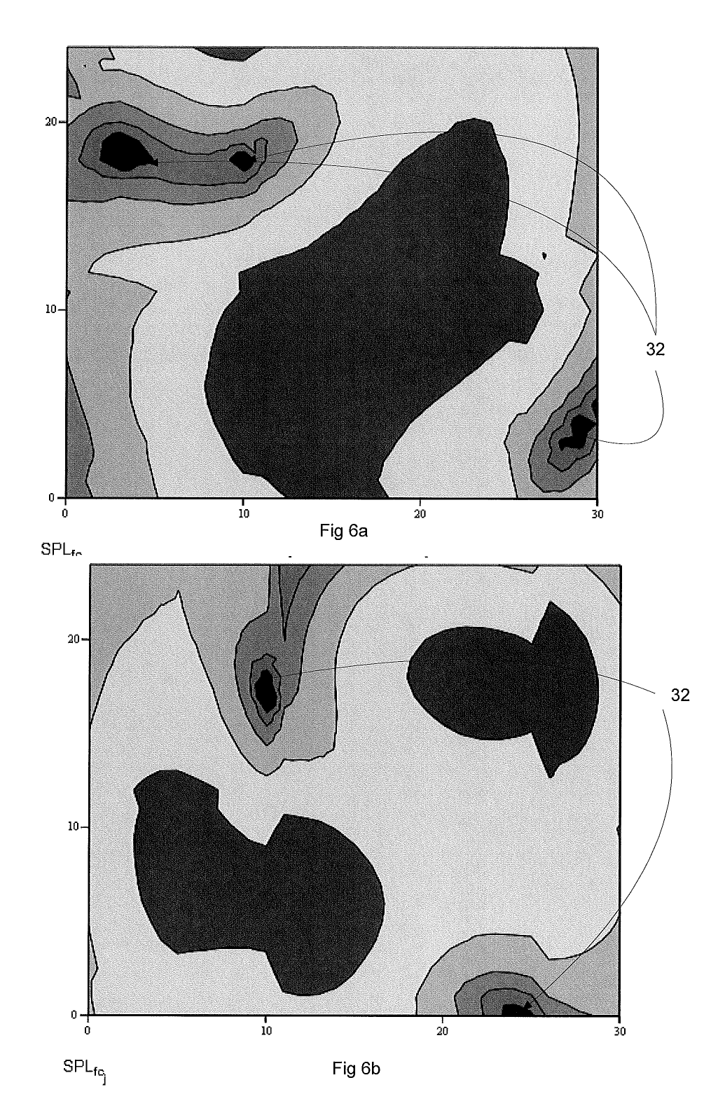

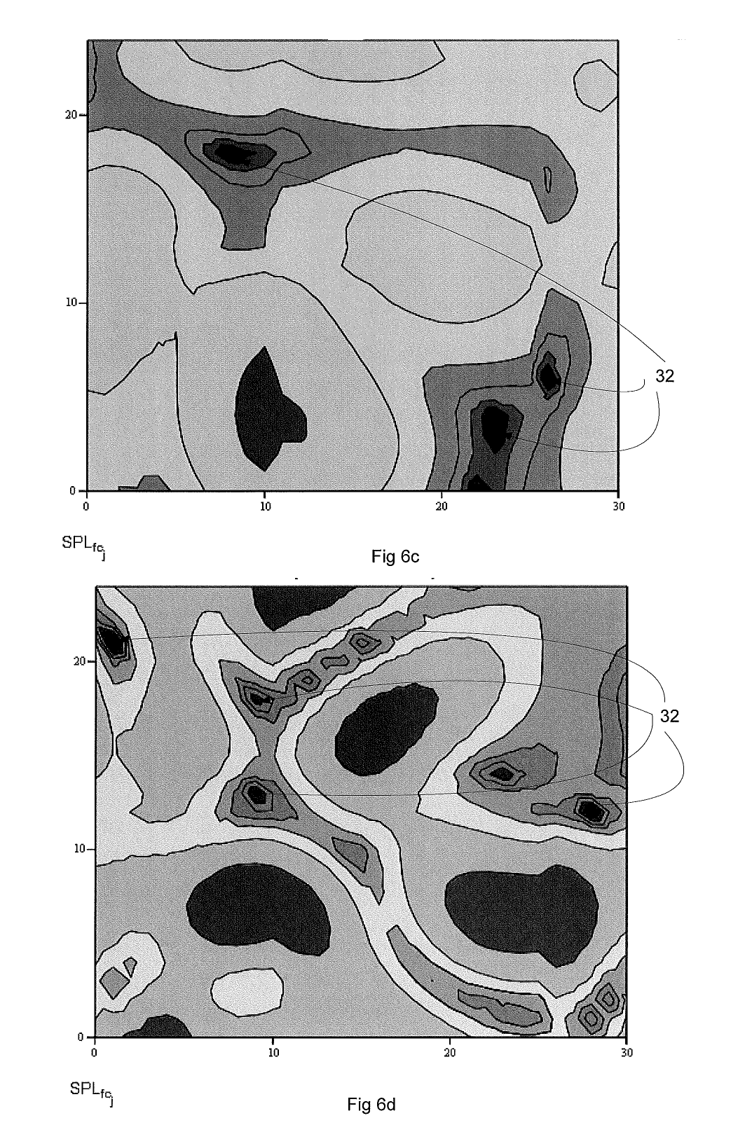

FIG. 2 shows the cabin model used to create a mirror model “ray-trace” simulation based on a simplified car model to provide quick frequency response calculations to test the validity of the approach. The simulation technique is described in Harris, N.J. “A Comparison of modelling techniques for small acoustic spaces such as car cabins”, AES Convention Paper 7146, presented at the 122^{nd} AES Convention, 2007, May 5-8, Vienna, Austria. The internal horizontal plane near the top is the listening plane 30 and used to plot the sound pressure level (SPL) contours of FIGS. 4a and 4b and FIGS. 6a to 6d. This internal horizontal plane is clearly in the near field of the sources (i.e. most of the radiation is received by the listener direct from the sources without reflection from other surfaces in the enclosed space). The upper four non-horizontal planes are largely glass and are given reflection coefficients of 0.9. The lower four non-horizontal planes are given reflection coefficients of 0.8 for the front, 0.5 for the back and 0.6 for the sides. The source plane also has a reflection coefficient of 0.6. These values are arbitrary but realistic.

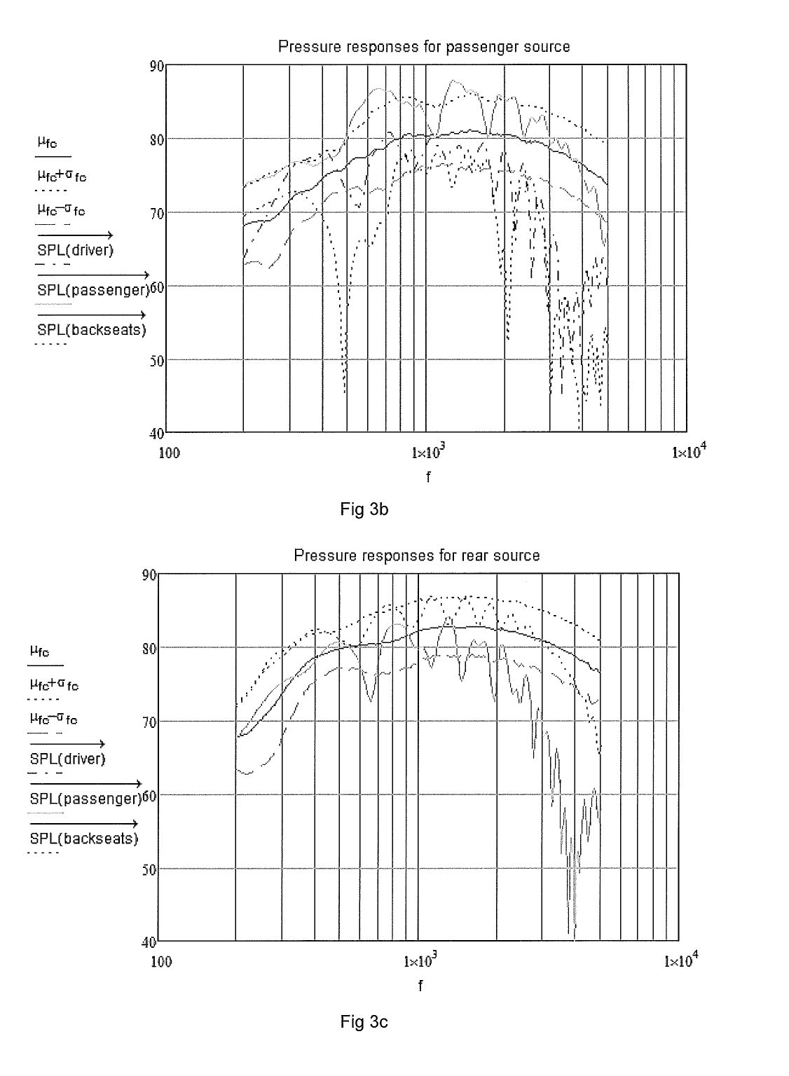

The arrangement shown in FIG. 1a is modelled using the model of FIG. 2 at low frequencies. The first step in the method is to measure the frequency response at each target position, i.e. driver, passenger and backseats, for each of the three sources shown in FIG. 1a. FIG. 3a shows the sound pressure levels at each location when only the driver sources are activated. The measured sound pressure levels at each target position are compared with the mean range (μ_{mc}) for each exciter calculated from all responses. The standard deviation for the mean range is also plotted (μ_{mc}−σ_{mc} and μ_{mc}+σ_{mc}).

As expected, the sound pressure levels for the driver is greatest with a drop off at the passenger location with a further drop off in sound pressure levels for the backseat. As shown in FIG. 3b, mirror image results are achieved when only the passenger sources are active. As shown in FIG. 3c, if only the rear source is active both the driver and passenger receive a poor output. FIGS. 4a and 4b confirm these results and show the sound pressure levels at 800 Hz plotted across the whole listening plane. Since there is a simple mirror symmetry between driver and passenger, so only one result (FIG. 4a) is shown. FIG. 4b shows the results for the rear source. The quiet spots 32 of maximum output are at the edge of the cabin on the passenger side in FIG. 4a. In FIG. 4b, there are a pair of symmetrically placed quiet spots 32 towards the front and a single hotspot 32 centrally placed at the rear of the listening plane.

The next step is to calculate a transfer function for each source, namely (iₚ^{T})^{<0>} for the driver source, (iₚ^{T})^{<1>} for the passenger source and (iₚ^{T})^{<2>} for the rear source.

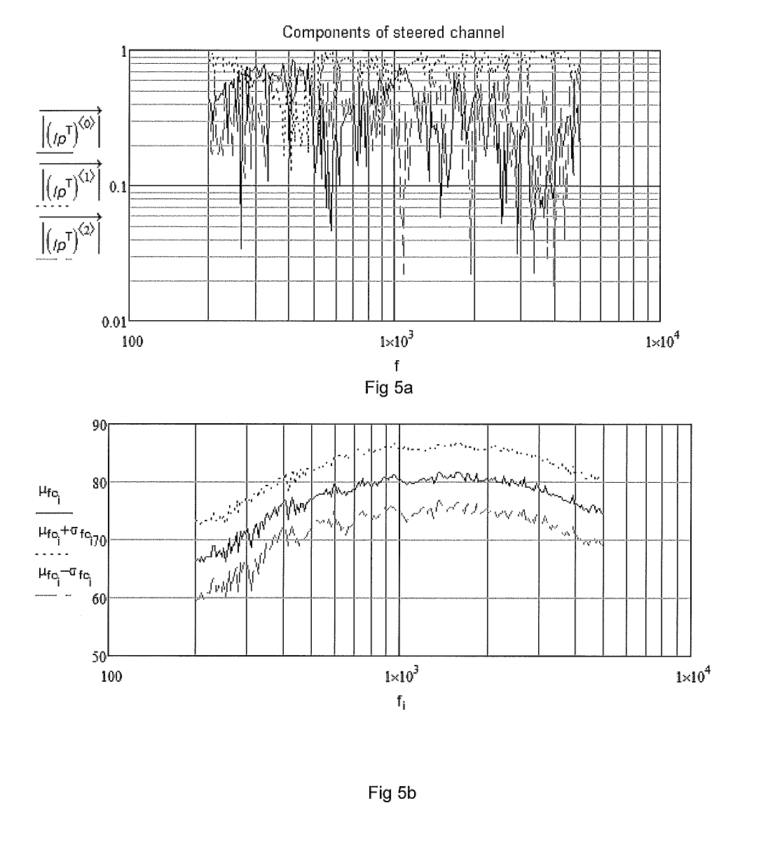

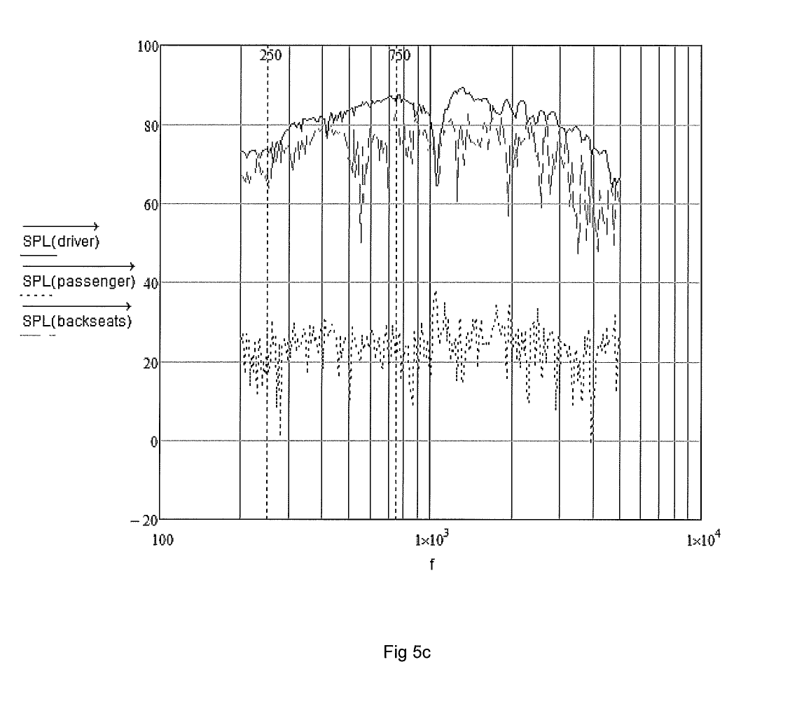

FIG. 5a shows the transfer functions (iₚ^{T})^{<u>} for each source which are necessary to maximise the driver SPL and minimise the passenger SPL. To reverse the roles of the driver and passenger, it is merely necessary to swap the solid and dotted traces. FIG. 5b shows the mean responses (μ_{mc}) for each source calculated from all responses. The standard deviation for the mean range is also plotted (μ_{mc}−σ_{mc} and μ_{mc}+σ_{mc}). These mean responses show no obvious coloration. This results from the fact that these transfer functions are all-pass, in the sense that as a group, they produce a new power gain of unity at all frequencies.

As shown in FIG. 5c, the sound output at the driver location (loud zone) is approximately 50-60 dB greater than that at the passenger location (quiet zone). The sound output at the rear seats is less than that at the driver location but is significantly greater than in the quiet zone. FIGS. 6a to 6d show the output in the listening plane. The quiet spots 32 are in significantly different locations to those of FIGS. 4a and 4b. At each frequency (283 Hz, 400 Hz, 576 Hz and 800 Hz), the quiet spots are generally located above the passenger with no corresponding quiet spots near the driver (the vehicle is left-hand drive). There are some quiet spots over the rear seats which is in line with the results of FIG. 5c.

Experimental results in structural acoustics suggests that approximately 15-20 db separation is more realistic. It is also noted that although the separation between zones remains good to high frequencies, the area over which separation applies reduces in proportion to the wavelength. There is one problematic frequency, just above 1 kHz, which based on the results in structural acoustics, is due to the presence of a modal anti-node at the listener location at this frequency.

The transfer functions may be calculated formally by the various methods detailed below. For any multi-region system, there are a number of inputs and a number of measurement points. The simplest case is two inputs and one target position, but as described above the problem may be considerably more complicated, involving more inputs, and extended target areas. The various methods of solving both the simple and more complex problems are described below:

A Simple Minimisation Problem & Solution by “Tan Theta” Approach

Consider a system with two inputs and one output. Let the transfer function from input 1 (e.g. the first low frequency source in FIG. 1a) to the output be represented by P1, and the transfer function from input 2 (e.g. the low frequency source in FIG. 1a) to the output be represented by P2. Then, for input signals a and −b, the output signal spectrum T is given by

T=a.P1−b.P2

where a, b, P1, P2 and T are all complex functions of frequency.

The problem to be solved is minimising T for all frequencies. There is no unique solution to the problem, but it is clear from observation that a and b should be related; specifically

b=a.P1/P2, or a=b.P2/P1

Using these ratios is generally not a good idea, as either P1 or P2 may contain zeros. One simple solution is to set a=P2 and b=P1. It is also general practice to normalise the solution to unit energy, that is |a|²+|b|²=1. As P1 and P2 are in general complex quantities, the absolute values are important. Thus, T is minimised by setting:

$$a = \frac{P 2}{\sqrt{{\vert P 1 \vert}^{2} + {\vert P 2 \vert}^{2}}} , b = \frac{P 1}{\sqrt{{\vert P 1 \vert}^{2} + {\vert P 2 \vert}^{2}}}$$

Incidentally, T is maximised to unity by setting

$$a = \frac{\overline{P 1}}{\sqrt{{\vert P 1 \vert}^{2} + {\vert P 2 \vert}^{2}}} , b = - \frac{\overline{P 2}}{\sqrt{{\vert P 1 \vert}^{2} + {\vert P 2 \vert}^{2}}}$$

If P1 or P2 are measured remote from the input, as is generally the case in acoustics, the transfer function will include excess phase in the form of delay. Consequently, these values of a and b may not be the best choice. If we set a=cos(θ) and b=sin(θ), then tan(θ)=P1/P2. This solution may be described as the “tan theta” solution and produces a and b with much less excess phase. It is clear that a²+b²=1 due to the trigonometric identity, but as θ is in general complex, |a|²+|b|²≠1, so normalisation would still be required.

In this simple example, the minimisation problem was solved by inspection. As this may not be possible in general, it would be of advantage to have a systematic method of finding the solution.

### Variational Methods

The minimisation of energy functions is a key process in many branches of physical modelling with mathematics, and for example forms the foundation of finite element analysis. The task at hand is to determine values of parameters that lead to stationary values to a function (i.e. to find nodal points, lines or pressures). The first step of the process is forming the energy function. For our example, the squared modulus of T may be used, i.e. E=|T|²=|a.P1−b.P2|². The stationary values occur at the maximum and the minimum of E.

E=(a·P1−b·P2)· (̅a̅·̅P̅1̅−̅b̅·̅P̅2̅)̅

There is a constraint on the values of a and b—they cannot both be zero. This constraint may be expressed using a so called “Lagrange multiplier” to modify the energy equation, thus;

E=(a·P1−b·P2)· (̅a̅·̅P̅1̅−̅b̅·̅P̅2̅)̅+λ·(ā·a+ b̅·b·−1)

It is common in these types of problem to consider the complex conjugate of each variable as an independent variable. We shall follow the practice here, and differentiate E with respect to each conjugate variable in turn, thus;

$$\begin{matrix}\frac{\partial E}{\partial \overline{a}} = ( a \cdot P 1 - b \cdot P 2 ) \cdot \overline{P 1} + λ \cdot a & ( 1 ) \\ \frac{\partial E}{\partial \overline{b}} = - ( a \cdot P 1 - b \cdot P 2 ) \cdot \overline{P 2} + λ \cdot b & ( 2 )\end{matrix}$$

At the stationary points, both of these must be zero. It is possible to see straight away that the solutions found in the previous section apply here too. However, continuing to solve the system of equations formally, first the equations are combined to eliminate λ by finding:

(1).b−(2).a

(a·P1−b·P2)· P̅1̅·b+(a·P1−b·P2)· P̅2̅·a=0

The resulting equation is quadratic in a and b, the two solutions corresponding to the maximum and the minimum values of E. Introducing a=cos(θ) and b=sin(θ)—although strictly speaking this does not satisfy the Lagrange constraint—obtains a quadratic equation in tan(θ).

P1· P̅2̅+(|P1|²−|P2|²)·tan(θ)−P2· P̅1̅·tan(θ)²=0

Noting that in many cases, (P|1|²−|P2|²)^{²}4P1· P̅2̅·P2 · P̅1̅−(|P1|²+|P2|²)^{²}, we arrive at the same answers as before, namely

$$θ = arctan ( \frac{P 1}{P 2} )$$

for the minimum, and

$$θ = \overline{arctan ( - \frac{P 2}{P 1} )}$$

for the maximum.

For completeness, it is noted that this identity might not apply in the general case, where P1 and P2 are sums or integrals of responses. Nevertheless, it is possible to systematically find both stationary values using this variation of the “tan theta” approach. One application is explained in more detail below to illustrate how these solutions may be used in the examples described above.

### Application 2: Dual Zones

It is possible to simultaneously specify a minimal response at one location and a non-zero response at another position. This might be very useful in dual region systems.

### “Strong” Solution

We have two inputs (for example), to produce one nodal point and audio at another point. Define transfer functions Pi_j from input i to output j.

Simultaneously solve a.P1_{—}1+b.P2_{—}1=0 and a.P2_+b.P2_{—}2=g.

$$( \begin{matrix}P 1 \_ 1 & P 2 \_ 1 \\ P 1 \_ 2 & P 2 \_ 2\end{matrix} ) ( \begin{matrix}a \\ b\end{matrix} ) = ( \begin{matrix}0 \\ g\end{matrix} ) , ( \begin{matrix}a \\ b\end{matrix} ) = {( \begin{matrix}P 1 \_ 1 & P 2 \_ 1 \\ P 1 \_ 2 & P 2 \_ 2\end{matrix} )}^{- 1} ( \begin{matrix}0 \\ g\end{matrix} )$$

$$a = - \frac{P 2 \_ 1}{P 1 \_ 1 \cdot P 2 \_ 2 - P 1 \_ 2 \cdot P 2 \_ 1} \cdot g , \\ b = \frac{P 1 \_ 1}{P 1 \_ 1 \cdot P 2 \_ 2 - P 1 \_ 2 \cdot P 2 \_ 1} \cdot g$$

Provided the denominator is never zero, this pair of transfer functions will produce a nodal response at point 1, and a complex transfer function exactly equal to g at point 2.

### “Weak” Solution

Simultaneously solve |a.P1_{—}1+b.P2_P2_{—}1|²=0 and |a.P2_{—}1+b.P2_{—}2|³=|g|².

Use the variational methods discussed below to solve the first minimisation for a and b, and the normalise the result to satisfy the second equation.

a=r·cos(θ), b=−r·sin(74 ),

$$tan ( θ ) = - \frac{P 1 \_ 1}{P 1 \_ 2}$$

r²·|(cos(74 )·P2_{—}1−sin(θ)·P2_{—}2)|²=|g|², hence r.

Provided the denominator is never zero, this pair of transfer functions will produce a nodal response at point 1, and a power transfer function equal to |g|² at point 2. The resulting output at point 2 will not necessary have the same phase response as g, so the coercion is not as strong.

There are other extensions to the methods described above that are particularly relevant when considering more than two input channels. These extensions are general, and would equally well apply to the two-channel case. Additionally, by using eigenvalue analysis as a tool, we get the “best” solution when no exact solution is available.

Relationship between the variational method and the eigenvalue problem.

When minimising an energy function of the form E, below, we arrive at a set of simultaneous equations;

$$E = {\vert {\sum }_{n} {a}_{n} \cdot {P}_{n} \vert}^{2} , \frac{\partial E}{\partial \overline{{a}_{n}}} = \overline{{P}_{n}} \cdot {\sum }_{n} {a}_{n} \cdot {P}_{n} = 0 ,$$

for all n
where P, are the inputs to the system and a, the constants applied to these inputs, i.e. a and b in the previous two channel system.

We may write this system of equations in matrix form, thus

M·v0, where Mᵢⱼ−= P̅ᵢ·Pⱼ, and where vᵢ=aᵢ (1)

Note that M is conjugate symmetric, i.e. M_{i,j}= M̅_{i,j}

We wish to find a non-trivial solution; that is a solution other than the trivial v=0, which although mathematically valid, is not of much use.

As any linear scaling of v is also a solution to the equation, the a, are not uniquely defined. We need an additional equation to constrain the scaling. Another way of viewing things is to say that for an exact solution, the number of input variables must be greater than the number of measurement points. Either way, there is one more equation than free variables, so the determinant of M will be zero.

Consider the matrix eigenvalue problem, where we wish to find a non-trivial solution to the equation

M·v−λ·v=0, where λ is an eigenvalue, and the associated v is the eigenvector (2)

As M is conjugate symmetric, all the eigenvalues will be real and non-negative. If λ=0 is a solution to the eigenvalue problem, it should be clear that we have our original equation. So v is the eigenvector for λ=0.

What is particularly powerful about this method, is that even when there is no solution to (1), the solution to (2) with the smallest value of A is the closest approximate answer.

For example, using the problem posed above:

$$( \begin{matrix}\overline{P 1} \cdot P 1 & - \overline{P 1} \cdot P 2 \\ - \overline{P 2} \cdot P 1 & \overline{P 2} \cdot P 2\end{matrix} ) \cdot ( \begin{matrix}a \\ b\end{matrix} ) - λ \cdot ( \begin{matrix}a \\ b\end{matrix} ) = 0 ,$$

has a solution λ=0, b/a=P1/P2.

The other eigenvalue corresponds to the maximum; λ=|P1|²+|P2|², b/a= P̅2̅/̅P̅1̅

When using an eigenvalue solver to find the values of aᵢ, the scaling used is essentially arbitrary. It is normal practice to normalise the eigenvector, and doing so will set the amplitudes;

$${\sum }_{i} {\vert {a}_{i} \vert}^{2} = 1$$

For example,

$$a = \frac{P 2}{\sqrt{{\vert P 1 \vert}^{2} + {\vert P 2 \vert}^{2}}} , b = \frac{P 1}{\sqrt{{\vert P 1 \vert}^{2} + {\vert P 2 \vert}^{2}}}$$

The reference phase, however, is still arbitrary—if v is a normalised solution to the eigen-problem, then so is v.e^{jθ}. What constitutes the “best” value for θ, and how to find it is the subject of a later section.

The value of the eigenvalue λ is just the energy associated with that choice of eigenvector. The proof follows;

$$\begin{matrix}E = {\vert {\sum }_{n} {a}_{n} \cdot {P}_{n} \vert}^{2} \\ = {\sum }_{n} {a}_{n} \cdot {P}_{n} \cdot {\sum }_{m} \overline{{a}_{m}} \cdot \overline{{P}_{m}} \\ = {\sum }_{m} \overline{{a}_{m}} \cdot ( {\sum }_{n} \overline{{P}_{m}} \cdot {P}_{n} \cdot {a}_{n} ) \\ = {\sum }_{m} \overline{{a}_{m}} \cdot ( {\sum }_{n} {M}_{mn} \cdot {a}_{n} )\end{matrix}$$

From our eigenvalue equation and normalisation of the eigenvector, we can continue by stating

$$\begin{matrix}E = {\sum }_{m} \overline{{a}_{m}} \cdot ( {\sum }_{n} {M}_{mn} \cdot {a}_{n} ) \\ = {\sum }_{m} \overline{{a}_{m}} \cdot ( λ \cdot {a}_{m} ) \\ = λ \cdot {\sum }_{m} \overline{{a}_{m}} \cdot {a}_{m} \\ = λ\end{matrix}$$

### Solving the Eigenvalue Problem

In principle, a system of order n has n eigenvalues, which are found by solving an nth order polynomial equation. However, we don't need all the eigenvalues—only the smallest.

M·v−λ·v=0, leads to |M−λ·I|=0 , leads to

$${\prod }_{i = 1}^{n} ( λ - {λ}_{i} ) = 0$$

If there is an exact solution to the problem, the determinant will have λ as a factor. For example,

$$\vert ( \begin{matrix}a & b \\ \overline{b} & c\end{matrix} ) - λ \cdot ( \begin{matrix}1 & 0 \\ 0 & 1\end{matrix} ) \vert = \vert ( \begin{matrix}a - λ & b \\ \overline{b} & c - λ\end{matrix} ) \vert = ( a - λ ) ( c - λ ) - {\vert b \vert}^{2} = 0$$

a·c−|b|²−(a+c)·λ+λ²=0

If a.c−|b|²=0, then there is an exact solution.

As the number of equations is greater than the number of unknowns, there are more than one possible sets of solutions to v, but they are all equivalent;

$$( a - λ ) \cdot {v}_{0} + b \cdot {v}_{1} = 0 , \frac{{v}_{1}}{{v}_{0}} = \frac{λ - a}{b}$$

$$\overline{b} \cdot {v}_{0} + ( c - λ ) \cdot {v}_{1} = 0 , \frac{{v}_{1}}{{v}_{0}} = \frac{\overline{b}}{λ - c}$$

For example

a=2, b=1+1j, c=3; 6−2−5.λ+λ²=0; λ=1, 4

(λ−2)/(1+1j)=(−1+1j)/2 or 1−1j

(1−1j)/(λ−3)=(−1+1j)/2 or 1−1j

So the best solution to the pair of equations is given by v1/v0=(−1+1j)/2

Choosing the “Best” Scaling for the Solution

Mathematically speaking, any solution to the problem is as good as any other. However we are trying to solve an engineering problem. Both the matrix, M, and its eigenvectors, v, are functions of frequency. We wish to use the components of v as transfer functions, so having sudden changes of sign or phase is not preferred.

M(ω)·v(ω)=0

For the two-variable problem, we used the substitution a=cos(θ) and b=sin(θ), and the solved for tan(θ). This method seems to produce values of a and b with low excess phase. However, using this method quickly becomes unwieldy, as the equations get more and more complicated to form, never mind solve. For example, for 3 variables we have 2 angles and can use the spherical polar mapping to give a=cos(θ).cos(φ), b=cos(θ).sin(φ), c=sin(θ).

Instead, let us use the variational method to determine the “best” value for θ. We will define best to mean having the smallest total imaginary component.

Now, let v′=v.e^{jθ}, let v=vr+j.vi, and define our error energy as

$$\begin{matrix}SSE = {\sum }_{i} {IM ( {v}_{i}^{′} )}^{2} \\ = {\sum }_{i} {Im ( ( {vr}_{i} + j \cdot {vi}_{i} ) \cdot ( cos ( θ ) + j \cdot sin ( θ ) ) )}^{2} \\ = {\sum }_{i} {( {vi}_{i} \cdot cos ( θ ) + {vr}_{i} \cdot sin ( θ ) )}^{2}\end{matrix}$$

Let

rr=Re(v)·Re(v)=Σvrᵢ², ii=Im(v)·Im(v)=Σviᵢ₂, ri=Re(v)·Im(v)=Σvrᵢ·viᵢ

Then

SSE=cos(θ)².ii+2.cos(θ).sin(θ).ri+sin(θ)².rr

(For θ=0, SSE=ii, which is our initial cost. We want to reduce this, if possible).

Now differentiate with respect to θ to give our equation

2.(cos(θ)²−sin(θ)²).ri+2.cos(θ).sin(θ).(rr−ii)=0

Dividing through by 2.cos(θ) ², we get the following quadratic in tan(θ);

ri+tan(θ).(rr−ii)−tan(θ)².ri=0

Of the two solutions, the one that gives the minimum of SSE is

$$tan ( θ ) = \frac{rr - ii - \sqrt{{( rr - ii )}^{2} + 4 \cdot {ri}^{2}}}{2 \cdot ri}$$

If ri=0, then we have two special cases;

If ri=0 and rr>=ii, then θ=0.

If ri=0 and rr<ii, then θ=π/2.

The final step in choosing the best value for v is to make sure that the real part of the first component is positive (any component could be used for this purpose), i.e.

Step 1. v′=v.ei^{jθ}

Step 2 if v′₀<0, v′=−v′

### EXAMPLE

$$v = ( \begin{matrix}0.908 - 0.419 j \\ 0.770 - 0.638 j \\ 0.9999 - 0.01 j \\ 0.343 - 0.939 j\end{matrix} ) ,$$

rr=2.534, ii=1.466, ri=−1.204; solving gives θ=0.577

$${v}^{′} = ( \begin{matrix}0.990 + 0.143 j \\ 0.993 - 0.115 j \\ 0.844 + 0.537 j \\ 0.800 - 0.600 j\end{matrix} )$$

rr′=3.318, ii′=0.682, ri=0

Note that minimising ii simultaneously maximises rr and sets ri to zero.

Comparison of Techniques—a Worked Example

Consider a two-input device with two outputs. There will be exact solutions for minimising each output individually, but only an approximate solution to simultaneous minimisation.

Output 1 transfer admittances: P1_{—}1=0.472+0.00344j, P2_{—}1=0.479−0.129j

Output 2 transfer admittances: P1_{—}2=−0.206−0.195j, P2_{—}2=0.262+0.000274j

Form two error contribution matrices

$$M 1 = ( \begin{matrix}0.223 & 0.226 - 0.063 j \\ 0.226 + 0.063 j & 0.246\end{matrix} ) ; \vert M 1 \vert = 0 ,$$

i.e. exact solution possible

$$M 2 = ( \begin{matrix}0.080 & - 0.054 + 0.050 j \\ - 0.054 - 0.050 j & 0.069\end{matrix} ) ; \vert M 2 \vert = 0 ,$$

i.e. exact solution possible

$$M 1 + M 2 = ( \begin{matrix}0.303 & 0.171 - 0.012 j \\ 0.171 + 0.012 j & 0.315\end{matrix} ) ; \vert M 1 + M 2 \vert = 0.066$$

We now use the “tan theta” method to solve the three cases.

$${( \begin{matrix}a \\ b\end{matrix} )}_{1} = ( \begin{matrix}0.718 - 0.093 j \\ - 0.682 - 0.098 j\end{matrix} ) , {( \begin{matrix}a \\ b\end{matrix} )}_{2} = ( \begin{matrix}0.623 - 0.270 j \\ 0.692 + 0.244 j\end{matrix} ) , \\ {( \begin{matrix}a \\ b\end{matrix} )}_{1 + 2} = ( \begin{matrix}0.719 - 0.024 j \\ - 0.694 - 0.025 j\end{matrix} )$$

Now for the eigenvector method. I have two eigenvector solvers; one solves for all vectors simultaneously, and the other solves for a specific eigenvalue. They give numerically different answers when the vectors are complex (both answers are correct), but after applying the “best” scaling algorithm, both solvers give the same results as those above.

M1: eigenvalues, 0 and 0.469:

Eigenvector before scaling: (−0.698+0.195j, 0.689−0.0013j) or (0.724, −0.664-0.184j)

Eigenvector after scaling: (0.718−0.093j, −0.682−0.098j)

M2: eigenvalues, 0 and 0.149:

Eigenvector before scaling: (−0.5+0.46j, 0.734−0.0030j) or (0.498−0.462j, 0.724) Eigenvector after scaling: (0.623−0.270j, 0.692+0.244j)

M1+M2: eigenvalues, 0.137 and 0.480:

Eigenvector before scaling: (−0.717+0.051j, 0.695−0.0007j) or (0.719, −0.693-0.049j) Eigenvector after scaling: (0.719−0.024j, −0.694−0.025j)

Adding a 3^{rd} Input

Now consider the contributions from a third input channel.

Output 1 transfer admittance: P3_{—}1=−0.067-0.180j

Output 2 transfer admittance: P3_{—}2=0.264+0.0014j

Add These Contributions to the Error Matrices

$$M 1 = ( \begin{matrix}0.223 & 0.226 - 0.063 j & - 0.032 - 0.085 j \\ 0.226 + 0.063 j & 0.246 & - 0.009 - 0.095 j \\ - 0.032 + 0.085 j & - 0.009 + 0.095 j & 0.037\end{matrix} ) ; \vert M 1 \vert = 0$$

$$M 2 = ( \begin{matrix}0.080 & - 0.054 + 0.050 j & - 0.055 + 0.051 j \\ - 0.054 - 0.050 j & 0.069 & 0.069 - 0.0004 j \\ - 0.055 - 0.051 j & 0.069 + 0.0004 j & 0.070\end{matrix} ) ; \vert M 2 \vert = 0$$

$$M 1 + M 2 = ( \begin{matrix}0.303 & 0.171 - 0.012 j & - 0.087 - 0.034 j \\ 0.171 + 0.012 j & 0.315 & 0.061 - 0.095 j \\ - 0.087 + 0.034 j & 0.061 + 0.095 j & 0.107\end{matrix} ) ;$$

$$\vert M 1 + M 2 \vert = 0$$

Now there is an exact solution to the joint problem, and M1+M2 has a zero eigenvalue.

(Note that M1 and M2 individually have two zero eigenvalues each—in other words they have a degenerate eigenvalue. There are two completely orthogonal solutions to the problem, and any linear sum of these two solutions is also a solution).

M1+M2: eigenvalues are 0, 0.218 and 0.506:

Eigenvector after scaling: (0.434−0.011j, −0.418+0.199j, 0.764+0.115j)

As illustrated above, for two inputs, the “tan theta” method is quicker and simpler to implement, however for three or four inputs the “scaled eigenvector” method is easier. Both methods produce the same result. For an exact solution, the number of input variables must be greater than the number of measurement points. By using eigenvalue analysis as a tool for the general problem, we get the “best” solution when no exact solution is available.

For the general ‘m’ input, ‘n’ output minimisation problem there are two principle variations on an algorithm to find the best m inputs. These may be referred to as the parallel “all at once” method and the serial “one at a time” method. In general, these may be combined at will. If m>n, then all routes end up with the same, exact answer (within rounding errors). If m<=n, then there are only approximate answers, and the route taken will affect the final outcome. The serial method is useful if m<=n, and some of the n outputs are more important than others. The important outputs are solved exactly, and those remaining get a best fit solution.

The Parallel, “All At Once” Algorithm

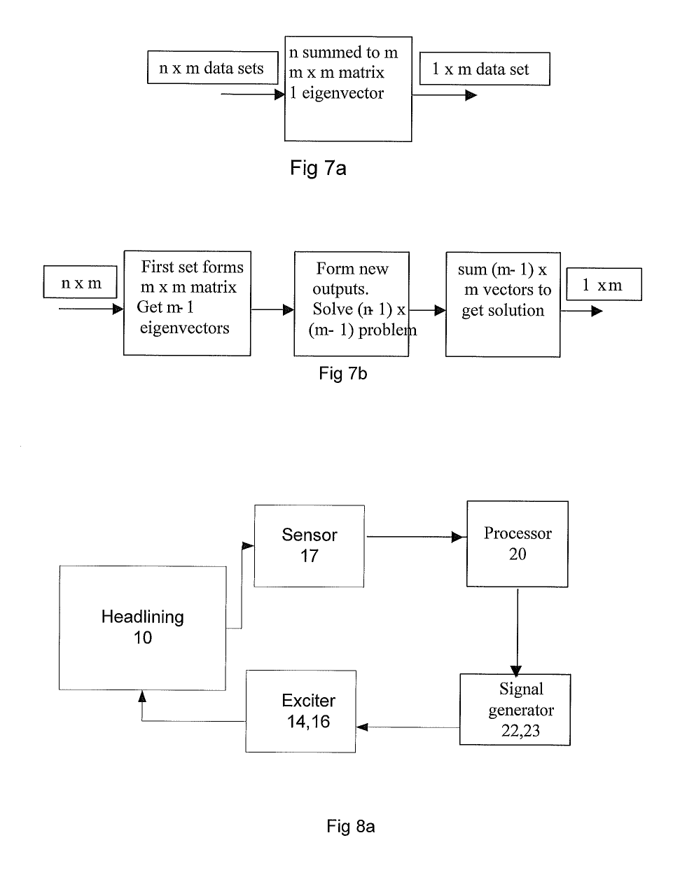

FIG. 7a is a block diagram of a parallel solver. One error matrix is formed, and the eigenvector corresponding to the lowest eigenvalue is chosen. If m>n, then the eigenvalue will be zero, and the result exact.

The Recursive or Sequential, “One At A Time” Algorithm

FIG. 7b is a block diagram of a recursive solver. An error matrix for the most important output is formed, and the eigenvectors corresponding to the (m−1) lowest eigenvalues are formed. These are used as new input vectors, and the process is repeated. The process ends with a 2×2 eigenvalue solution. Backtracking then reassembles the solution to the original problem.

As with all recursive algorithms, this process could be turned into an iterative (or sequential) process. For the first m−2 cycles, all the outputs have exact solutions. For the remaining cycle, the best linear combination of these solutions is found to minimise the remaining errors.

### Example 1

### m=3, n=2

Output 1 transfer admittances: P1_{—}1=0.472+0.00344j

Output 2 transfer admittances: P1_{—}2=−0.206−0.195j

Output 1 transfer admittances: P2_{—}1=0.479−0.129j

Output 2 transfer admittances: P2_{—}2=0.262+0.000274j

Output 1 transfer admittance: P3_{—}1=−0.067−0.180j

Output 2 transfer admittance: P3_{—}2=0.264+0.0014j

All at once

$$M 1 + M 2 = ( \begin{matrix}0.303 & 0.171 - 0.012 j & - 0.087 - 0.034 j \\ 0.171 + 0.012 j & 0.315 & 0.061 - 0.095 j \\ - 0.087 + 0.034 j & 0.061 + 0.095 j & 0.107\end{matrix} ) ;$$

$$\vert M 1 + M 2 \vert = 0$$

M1+M2: eigenvalues are 0, 0.218 and 0.506:

Eigenvector after scaling: (0.434−0.011j, −0.418+0.199j, 0.764+0.115j)

One at a Time

Solve output 1, and then output 2. As 3>2 we should get the same answer.

$$M 1 = ( \begin{matrix}0.223 & 0.226 - 0.063 j & - 0.032 - 0.085 j \\ 0.226 + 0.063 j & 0.246 & - 0.009 - 0.095 j \\ - 0.032 + 0.085 j & - 0.009 + 0.095 j & 0.037\end{matrix} ) ;$$

$$\vert M 1 \vert = 0$$

M1: eigenvalues are 0, 0 and 0.506:

Eigenvector V1: (0.748, −0.596−0.165j, 0.085−0.224j)

Eigenvector V2: (−0.062+0.026j, 0.096+0.350j, 0.929)

New problem; select a and b such that a.V1+b.V2 minimises output 2.

New transfer admittances are;

pv1=(P1_{—}2 P2_{—}2 P3_{—}2).V1=−0.287−0.250j

pv2=(P1_{—}2 P2_{—}2 P3_{—}2).V1=0.287+0.100j

We now repeat the process using these two transfer admittances as the outputs.

New error matrix is

$$M {1}^{′} = ( \begin{matrix}0.145 & - 0.107 + 0.043 j \\ - 0.107 - 0.043 j & 0.093\end{matrix} ) ; \vert M {1}^{′} \vert = 0 ,$$

i.e. exact solution possible

M1′ eigenvalues, 0 and 0.237

Eigenvector after scaling: (0.608−0.145j, 0.772+0.114j)

Now combine V1 and V2 to get the inputs

(0.608−0.145j) V1+(0.772+0.114) V2=(0.404−0.095j, −0.352+0.268j, 0.737−0.042j)

Normalise and scale the result: (0.434−0.011j, −0.418+0.199j, 0.764+0.115j)

Notice that this is the same as before, just as it should be.

### Example 2

### m=3, n>=3

Here we have 1 acoustic pressure output and a number of velocity outputs.

Acoustic scaled error matrix is M1, summed velocity scaled error matrix is M2.

$$M 1 = ( \begin{matrix}3.928 & - 2.667 + 2.473 j & - 2.674 + 2.506 j \\ - 2.667 - 2.473 j & 3.367 & 3.393 - 0.018 j \\ - 2.674 - 2.506 j & 3.393 + 0.018 j & 3.418\end{matrix} ) ; \vert M 1 \vert = 0$$

$$M 2 = ( \begin{matrix}1.023 & 0.602 - 0.112 j & - 0.528 + 0.409 j \\ 0.602 + 0.112 j & 0.977 & - 1.144 + 0.205 j \\ - 0.528 - 0.409 j & - 1.144 - 0.205 j & 5.473\end{matrix} ) ;$$

$$\vert M 2 \vert = 2.510$$

All at Once

All n output error matrices are summed and the eigenvector corresponding to the lowest eigenvalue is found.

Eigenvalues(M1+M2)=1.146, 3.869, 13.173

Solution=(0.739−0.235j, 0.483+0.306j, 0.246+0.104j)

One at a Time

Actually, we solve just the acoustics problem, then do the rest all at once. That way, the acoustics problem is solved exactly.

Eigenvalues(M1)=0, 0, 10.714

V1=(0.770−0.199j, 0.376+0.202j, 0.377+0.206j)

V2=(0.097−0.071j, 0.765+0.010j, −0.632+0.0016j)

As V1 and V2 both correspond to a zero eigenvalue, a.V1+b.V2 is also an eigenvector corresponding to a zero eigenvalue—i.e. it is an exact solution to the acoustics problem.

Form the “all at once” minimisation for the structural problem using a and b.

$$M {2}^{′} = ( \begin{matrix}1.314 & - 0.381 + 0.341 j \\ - 0.381 - 0.341 j & 0.093\end{matrix} ) ; \vert M {2}^{′} \vert = 5.098$$

M1′ eigenvalues, 1.222 and 4.172

Eigenvector after scaling: (0.984−0.016j, 0.113+0.115j)

Now combine V1 and V2 to get the inputs

(0.984−0.016j) V1+(0.113+0.115j) V2=(0.776−0.207j, 0.473+0.283j, 0.290−0.124j)

Normalise and scale the result: (0.755−0.211j, −0.466+0.270j, 0.246+0.104j)

Notice that this is similar, but not identical to the “all at once” solution. When extended to cover a range of frequencies, it gives a precise result to the acoustics problem, where numerical rounding causes the very slight non-zero pressure in the sequential case).

As set out above, the two methods are not mutually exclusive, and the parallel method may be adopted at any point in the sequential process, particularly to finish the process. The sequential method is useful where the number of inputs does not exceed the number of outputs, particularly when some of the outputs are more important than others. The important outputs are solved exactly, and those remaining get a best fit solution.

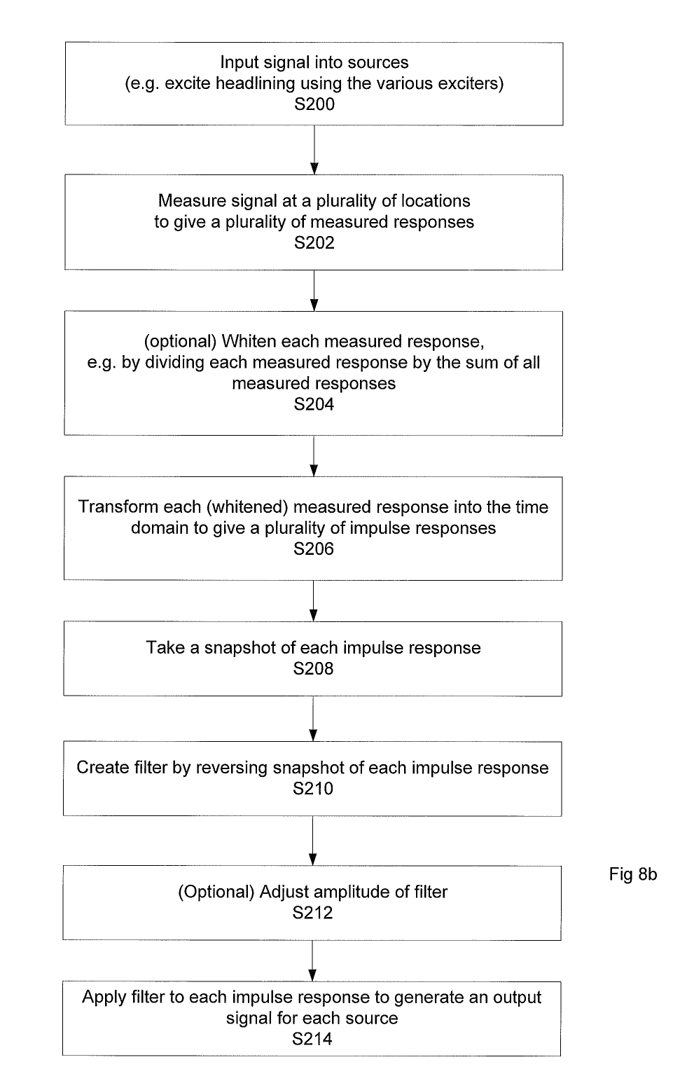

As an alternative to the formal methodologies detailed above, the system may be self calibrating. FIG. 8a shows a variation of the system of FIG. 1 d which has two operational modes, normal use and training mode. FIG. 8b shows the methods of the training mode. In normal use, i.e. when a user is listening to audio, the exciters 14,16 excite the headlining 10 to produce audio feedback. In training mode, the exciters 14,16 are used to inject vibrational signals into the headlining and sensors 17 are used to detect the audio output generated by these input signals. As shown, the sensors are separate from the exciters but the exciters may be reciprocal transducers able to work as both output devices to generate excitation signals which create vibration and as input devices to sense audio output and convert the vibration into input responses to be analysed. The system processor 20 generates the signals which are sent to the exciters 14, 16 and receives the signals from the sensors 17.

The processor generates output signals for each exciter which are the results of filtering the input responses (i.e. measured responses). The input responses are filtered by matched filters which are created by the system processor 20 by inverting the impulse responses. In other words, first filtered signal tt1ᵢ is created by filtering first input signal h1ᵢ using the inverted input signal h1ᵢ. Similarly second filtered signal tt2ᵢ is created by filtering second input signal h2ᵢ using the inverted input signal h2ᵢ. The sum of the normalized matched filter responses (i.e. in-phase combination) reinforces the signal at the measurement point and the difference of the normalized matched filter responses (i.e. out-of-phase combination) results in cancellation at the measurement point.

As shown in FIG. 8b, the first step S200 is to input a signal into the headlining at the sources and to measure this input signal at a plurality of locations in the listening plane (S202). As an approximation, the responses may be measured at the headlining by the input transducers. Each measured response is optionally whitened (S204) and then transformed into the time domain (S206). A filter is formed by taking a snapshot of each impulse response (S208) and reversing this snapshot (S210).

The spectrum of the time-reversed signal is the complex conjugate of the original original: x(t)−>X(f)

filter: y(t)=x(−t); Y(f)=conj(X(f))

This is approximated by adding a fixed delay, so

z(t)=x(T−t) if t<=T, or z(t)=0 if t>T

When the filter is applied to the signal (ignoring the approximation for now), the phase information is removed, but the amplitude information is reinforced.

y(t)*x(t)−>X(f)×Y(f)=|X(f)|_{Λ}2

(In fact, the resulting time response is the autocorrelation function).

As shown in step S212, the filter amplitude may adjusted, e.g. using a snapshot of 5 ms, 10 ms or other times. The filter is then applied to each impulse response to generate an output signal to be applied at each source (S214).

No doubt many other effective alternatives will occur to the skilled person. It will be understood that the invention is not limited to the described embodiments and encompasses modifications apparent to those skilled in the art lying within the spirit and scope of the claims appended hereto.

1. Apparatus for providing different audio signals in a plurality of zones of a single enclosed space, comprising:
loudspeakers associated with, and positioned in, each zone to radiate an audio output,
an audio signal supply configured to supply a different audio signal to the loudspeakers in each zone, and
a signal processor comprising:
an audio frequency divider configured to divide the audio frequency spectrum of each audio signal into higher and lower parts,
a high frequency controller configured to direct the higher frequencies radiated in their respective zones, and
a low frequency controller configured to vary any of the amplitude, phase and delay of the lower frequencies to tend to cancel sound radiation outside their respective zones.

2. Apparatus according to claim 1, wherein the enclosed space is the cabin of a vehicle.

3. Apparatus according to claim 2, wherein the vehicle is an automobile.

4. Apparatus according to claim 2, wherein the cabin is trimmed internally with at least one resilient panel, and wherein at least one of the loudspeakers in each zone is coupled to drive a portion of the at least one trim panel as an acoustic diaphragm.

5. Apparatus according to claim 2, wherein the cabin is trimmed internally with a head-lining, and wherein at least one of the loudspeakers in each zone is coupled to drive a portion of the head-lining as an acoustic diaphragm.

6. Apparatus according to claim 1, wherein the loudspeakers in each zone comprise a cluster having at least one lower frequency driver and an array of higher frequency drivers.

7. Apparatus according to claim 6, wherein the the high frequency controller processes the higher frequency signal to the array of higher frequency drivers to control the directivity of the radiation from the array.

8. Apparatus according to claim 1, wherein the audio frequency divider is arranged so that the division occurs at around 1500 Hz.

9. Apparatus according to claim 6, wherein the low frequency controller employs linear superposition for the lower frequencies of the different audio signals to tend to cancel sound radiation of the audio signals outside their respective zones.

10. Apparatus according to claim 9, wherein the at least one lower frequency driver in or associated with each zone is a bending wave diaphragm positioned in the near field with respect to a listener in the same zone.

11. A method of providing different audio signals in a plurality of zones of a single enclosed space, comprising
arranging loudspeakers in or adjacent to each zone to radiate an audio output in the associated zone,
supplying a different audio signal to the loudspeakers in each zone,
processing the audio signals including dividing the audio frequency spectrum of each audio signal into higher and lower parts,
directing the higher frequencies radiated in their respective zones, and
varying any of the amplitude, phase and delay of the lower frequencies to tend to cancel sound radiation outside their respective zones.

12. A method according to claim 11, comprising arranging the enclosed space to be the cabin of a vehicle.

13. A method according to claim 12, comprising arranging the vehicle to be an automobile.

14. A method according to claim 12, comprising trimming the cabin internally with at least one resilient panel, and coupling at least one of the loudspeakers in each zone to drive a portion of the at least one trim panel as an acoustic diaphragm.

15. A method according to claim 12, comprising trimming the cabin internally with a head-lining, and coupling at least one of the loudspeakers in each zone to drive a portion of the head-lining as an acoustic diaphragm.

16. A method according to claim 11, comprising providing a cluster of the loudspeakers in each zone and arranging that each cluster has at least one lower frequency driver and an array of higher frequency drivers.

17. A method according to claim 16, comprising processing the higher frequency signal to the array of higher frequency drivers to control the directivity of the radiation from the array.

18. A method according to claim 11, comprising arranging the audio frequency dividing so that the division occurs at around 15001 Hz.

19. A method according to claim 16, comprising arranging the signal processing to employ linear superposition for the lower frequencies of the different audio signals to tend to cancel sound radiation of the audio signals outside their respective zones.

20. A method according to claim 19, comprising arranging that the or each lower frequency driver in or associated with each zone is a bending wave diaphragm positioned in the near field with respect to a listener in the same zone.
